(19) United States
(12) Patent Application Publication
(10) Pub. No.: US 2026/0246595 A1
(43) Pub. Date: Aug. 20, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Jing Wang, Haidian District, Beijing (CN); Lan Chen, Haidian District, Beijing (CN)

(73) Assignee: NTT DOCOMO, INC., Tokyo (JP)

(21) Appl. No.: 18/876,573

(22) PCT Filed: Jun. 30, 2022
(86) PCT No.: PCT/JP2022/026384

§ 371 Date: Dec. 18, 2024

(51) Int. Cl. H04L 5/00; H04B 7/0404; H04W 72/21

(52) U.S. Cl. CPC H04L 5/0094; H04B 7/0404; H04W 72/21

(57) ABSTRACT

A terminal according to one aspect of the present disclosure includes a transmitting section that transmits a plurality of transport blocks to a plurality of transmission/reception points (TRPs) by using an uplink shared channel (Physical Uplink Shared Channel (PUSCH)), and a control section that judges a parameter related to an initial value for generation of a scrambling sequence to be applied to the PUSCH. According to one aspect of the present disclosure, it is possible to appropriately perform PUSCH transmission.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, Rel-18 NR), it is studied that a user terminal (User Equipment (UE)) transmits a plurality of codewords (CWs) or a plurality of transport blocks (TBs) by using an uplink shared channel (Physical Uplink Shared Channel (PUSCH)). However, progress has not been sufficiently made on a study of details of this operation. For example, for a case where the plurality of CWs or the plurality of TBs are transmitted by the PUSCH, a study has not been sufficiently made on how to control scrambling, size calculation (for example, a TB size), repetition transmission, and the like. Unless the PUSCH transmission for the plurality of CWs or the plurality of TBs is appropriately performed, throughput reduction and degradation in communication quality may occur.

Thus, an object of the present disclosure is to provide a terminal, a radio communication method, and a base station that appropriately perform PUSCH transmission.

### Solution to Problem

A terminal according to one aspect of the present disclosure includes a transmitting section that transmits a plurality of transport blocks to a plurality of transmission/reception points (TRPs) by using an uplink shared channel (Physical Uplink Shared Channel (PUSCH)), and a control section that judges a parameter related to an initial value for generation of a scrambling sequence to be applied to the PUSCH.

### Advantageous Effects of Invention

According to one aspect of the present disclosure, it is possible to appropriately perform PUSCH transmission.

### BRIEF DESCRIPTION OF DRAWINGS

FIGS. 1A and 1B are diagrams to show examples of single-panel UL transmission.

FIGS. 2A to 2C are diagrams to show examples of schemes 1 to 3 for simultaneous UL transmission using multi-panel.

FIG. 3 is a diagram to show an example of PUSCH repetition transmissions to which TDM is applied.

FIGS. 4A to 4D are diagrams to show variations of PUSCH repetition transmission.

FIGS. 5A to 5C are diagrams to show other variations of the PUSCH repetition transmission.

FIGS. 6A to 6B are diagrams to show examples of a TCI state indicated by a TCI codepoint.

FIG. 7 is a diagram to show an example of a schematic structure of a radio communication system according to one embodiment.

FIG. 8 is a diagram to show an example of a structure of a base station according to one embodiment.

FIG. 9 is a diagram to show an example of a structure of a user terminal according to one embodiment.

FIG. 10 is a diagram to show an example of a hardware structure of the base station and the user terminal according to one embodiment.

FIG. 11 is a diagram to show an example of a vehicle according to one embodiment.

### DESCRIPTION OF EMBODIMENTS

### (Repetition Transmission)

In Rel. 15, repetition transmission is supported in data transmission. For example, a base station (a network (NW), a gNB) may repeat transmission of DL data (for example, a downlink shared channel (PDSCH)) certain times. Alternatively, a UE may repeat UL data (for example, an uplink shared channel (PUSCH)) certain times.

A certain number of repetitions of PUSCH transmission may be scheduled for the UE by a single piece of DCI. The number of repetitions is also referred to as a repetition factor K or an aggregation factor K.

The n th repetition is also referred to as the n th transmission occasion and so on, and may be identified by a repetition index k (0≤k≤K−1). The repetition transmission may be applied to a PUSCH dynamically scheduled by the DCI (for example, a dynamic grant-based PUSCH), or may be applied to a configured grant-based PUSCH.

The UE semi-statically receives information indicating a repetition factor K (for example, aggregationFactorUL or aggregationFactorDL) by using higher layer signaling. Here, for example, the higher layer signaling may be any one or combinations of RRC (Radio Resource Control) signaling, MAC (Medium Access Control) signaling, broadcast information, and the like.

For example, the MAC signaling may use MAC control elements (MAC CE), MAC PDUs (Protocol Data Units), and the like. For example, the broadcast information may be master information blocks (MIBs), system information blocks (SIBs), minimum system information (RMSI (Remaining Minimum System Information)), and the like.

The UE controls PDSCH reception processing (for example, at least one of reception, demapping, demodulation, and decoding) or PUSCH transmission processing (for example, at least one of transmission, mapping, modulation, and coding) in K consecutive slots, based on at least one field value of the following (or information indicated by the field value) in the DCI:
Allocation of a time domain resource (for example, a start symbol, the number of symbols in each slot, or the like),
Allocation of a frequency domain resource (for example, a certain number of resource blocks (RBs) or a certain number of resource block groups (RBGs)),
A modulation and coding scheme (MCS) index,
Configuration of a PUSCH demodulation reference signal (DMRS), and
PUSCH spatial relation information (spatial relation info) or a transmission configuration indication (TCI (Transmission Configuration Indication or Transmission Configuration Indicator)) state (TCI state (TCI-state)).

Identical symbol allocations may be applied to the K consecutive slots. The UE may determine symbol allocation in each slot, based on a start symbol S and the number L of symbols (for example, a Start and Length Indicator (SLIV)) determined based on a value m of a certain field (for example, a time domain resource allocation (TDRA) field) in DCI. Note that the UE may determine the first slot, based on K2 information determined based on the value m of the certain field (for example, the TDRA field) of the DCI.

On the other hand, in the K consecutive slots, redundancy versions (RVs) applied to TBs based on identical data may be identical to each other or may be at least partially different from each other. For example, an RV applied to the TB in the n th slot (transmission occasion, repetition) may be determined based on a value of a certain field (for example, an RV field) in the DCI.

In Rel. 15, a PUSCH can be repetitively transmitted over a plurality of slots (in units of a slot). Rel. 16 (or later versions) supports PUSCH repetition transmission in units of anything shorter than the slot (for example, units of a sub-slot, units of a mini-slot, or units of a certain number of symbols).

The UE may determine symbol allocation for PUSCH transmission (for example, a PUSCH with k=0) in a certain slot, based on a start symbol S and the number L of symbols determined based on a value m of a certain field (for example, a TDRA field) in DCI for the PUSCH. Note that the UE may determine the certain slot, based on Ks information determined based on the value m of the certain field (for example, the TDRA field) of the DCI.

The UE may dynamically receive information indicating a repetition factor K (for example, numberofrepetitions) by using downlink control information. The repetition factor may be determined based on the value m of the certain field (for example, the TDRA field) in the DCI. For example, a table that defines correspondence between a bit value, a repetition factor K, a start symbol S, and the number L of symbols notified by the DCI may be supported.

The slot-based repetition transmission may be referred to as a repetition transmission type A (for example, PUSCH repetition Type A), and the sub-slot-based repetition transmission may be referred to as a repetition transmission type B (for example, PUSCH repetition Type B).

The UE may be configured with application of at least one of the repetition transmission type A and the repetition transmission type B. For example, a repetition transmission type to be applied by the UE may be notified from the base station to the UE by higher layer signaling (for example, PUSCHRepTypeIndicator).

One of the repetition transmission type A and the repetition transmission type B may be configured for the UE for each DCI format for scheduling the PUSCH.

For example, for a first DCI format (for example, DCI format 0_1), when higher layer signaling (for example, PUSCHRepTypeIndicator-AorDCIFormat0_1) is configured for the repetition transmission type B (for example, PUSCH-RepTypeB), the UE applies the repetition transmission type B to PUSCH repetition transmission scheduled by the first DCI format. Otherwise (for example, when PUSCH-RepTypeB is not configured or when PUSCH-RepTypeA is configured), the UE applies the repetition transmission type A to PUSCH repetition transmission scheduled by the first DCI format.

### (Scrambling of PUSCH)

In NR, the UE transmits data (codeword) by using a PUSCH. A bit of the codeword transmitted by using the PUSCH (which may be referred to as information bit) is scrambled before modulation processing.

Note that “scramble the bit transmitted by using the PUSCH” and “scramble the PUSCH” may be interchangeably interpreted.

A sequence used for the scrambling may be, for example, a gold sequence of a length of 31. A generator for this scrambling sequence is initialized by using an initial value cᵢₙᵢₜ. Here, cᵢₙᵢₜ=n_{RNTI}·2¹⁵+n^{ID} is defined.

In an existing Rel-15 NR specification, when a higher layer parameter for PUSCH scrambling identifier (ID) (“dataScramblingIdentityPUSCH”) is configured, a radio network temporary identifier (RNTI) is equal to a cell RNTI (C-RNTI), a Modulation Coding Scheme Cell RNTI (MCS-C-RNTI), a semi-persistent CSI-RNTI, or a configured scheduling RNTI (CS-RNTI), and transmission is not scheduled by using downlink control information (DCI) format 0_0 in a common search space, n_{ID} described above corresponds to a value (value from 0 to 1023) indicated by the above-described higher layer parameter for PUSCH scrambling ID (“dataScramblingIdentityPUSCH”). Otherwise, n_{ID} described above is a cell ID.

Note that the C-RNTI may mean a unique UE identifier used for scheduling as an RRC connection identifier. The CS-RNTI may mean a unique UE identifier used for downlink semi-persistent (SP) scheduling or uplink configured grant scheduling. The MCS-C-RNTI may mean a unique UE identifier used for indication of selection of an MCS table for PDSCH and PUSCH.

On the other hand, “n_{RNTI} corresponds to the RNTI associated with the PUSCH transmission and described in § 6.1 of TS 38.214” (“n_{RNTI} corresponds to the RNTI associated with the PUSCH transmission”) is defined. The n_{RNTI} may be referred to as a parameter related to an initial value for generation of a scrambling sequence.

### (Spatial Relations for SRS, PUSCH)

The UE may receive information used to transmit a reference signal for measurement (for example, a sounding reference signal (SRS)) (SRS configuration information, for example, a parameter in an RRC control element “SRS-Config”).

Specifically, the UE may receive at least one of information related to one or a plurality of SRS resource sets (SRS resource set information, for example, an RRC control element “SRS-ResourceSet”) and information related to one or a plurality of SRS resources (SRS resource information, for example an RRC control element “SRS-Resource”).

One SRS resource set may be associated with a certain number of SRS resources (may group the certain number of SRS resources together). Each SRS resource may be identified by an SRS resource indicator (SRI) or an SRS resource ID (Identifier).

The SRS resource set information may include an SRS resource set ID (SRS-ResourceSetId), a list of SRS resource IDs (SRS-ResourceId) used in the resource set, an SRS resource type, and information on SRS usage.

Here, the SRS resource type may indicate one of a periodic SRS (P-SRS), a semi-persistent SRS (SP-SRS), and an aperiodic SRS (A-SRS, AP-SRS). Note that the UE may periodically (or, after activation, periodically) transmit the P-SRS and the SP-SRS and may transmit the A-SRS, based on an SRS request of DCI.

The usage (RRC parameter “usage,” L1 (Layer-1) parameter “SRS-SetUse”) may be, for example, beam management (beamManagement), codebook based transmission (codebook (CB)), non-codebook based transmission (nonCodebook (NCB)), antenna switching, or the like. An SRS for codebook based transmission or non-codebook based transmission usage may be used to determine a precoder for codebook based or non-codebook based PUSCH transmission based on an SRI.

For example, in a case of codebook based transmission, the UE may determine a precoder for the PUSCH transmission, based on an SRI, a transmitted rank indicator (TRI), and a transmitted precoding matrix indicator (TPMI). In a case of non-codebook based transmission, the UE may determine a precoder for the PUSCH transmission, based on an SRI.

The SRS resource information may include an SRS resource ID (SRS-ResourceId), the number of SRS ports, an SRS port number, a transmission Comb, SRS resource mapping (for example, a time and/or frequency resource location, resource offset, a resource periodicity, the number of repetitions, the number of SRS symbols, an SRS bandwidth, or the like), hopping-related information, an SRS resource type, a sequence ID, SRS spatial relation information, and the like.

The SRS spatial relation information (for example, an RRC information element “spatialRelationInfo”) may indicate information on a spatial relation between a certain reference signal and an SRS. The certain reference signal may be at least one of a synchronization signal/broadcast channel (Synchronization Signal/Physical Broadcast Channel (SS/PBCH)) block, a channel state information reference signal (CSI-RS), and an SRS (for example, another SRS). The SS/PBCH block may be referred to as a synchronization signal block (SSB).

The SRS spatial relation information may include, as an index of the above-described certain reference signal, at least one of an SSB index, a CSI-RS resource ID, and an SRS resource ID.

Note that, in the present disclosure, an SSB index, an SSB resource ID, and an SSBRI (SSB Resource Indicator) may be interchangeably interpreted. A CSI-RS index, a CSI-RS resource ID, and a CRI (CSI-RS Resource Indicator) may be interchangeably interpreted. An SRS index, an SRS resource ID, and an SRI may be interchangeably interpreted.

The SRS spatial relation information may include a serving cell index, a BWP index (BWP ID), and the like corresponding to the above-described certain reference signal.

In NR, uplink signal transmission may be controlled based on the presence or absence of beam correspondence (BC). The BC may be, for example, a capability of a certain node (for example, the base station or the UE) to determine a beam (transmit beam or Tx beam) used for signal transmission, based on a beam (receive beam or Rx beam) used for signal reception.

Note that the BC may be referred to as transmit/receive beam correspondence (Tx/Rx beam correspondence), beam reciprocity, beam calibration, calibrated/non-calibrated, reciprocity calibrated/non-calibrated, a level of correspondence, a level of coincidence, and so on.

For example, when the BC is absent, the UE may transmit an uplink signal (for example, a PUSCH, a PUCCH, an SRS, or the like) by using a beam (spatial domain transmission filter) identical to that of an SRS (or SRS resource) indicated from the base station, based on a measurement result of one or more SRSs (or SRS resources).

On the other hand, when the BC is present, the UE may transmit an uplink signal (for example, a PUSCH, a PUCCH, an SRS, or the like) by using a beam (spatial domain transmission filter) identical to or corresponding to a beam (spatial domain reception filter) used for reception of a certain SSB or CSI-RS (or CSI-RS resource).

Regarding a certain SRS resource, when spatial relation information related to an SSB or CSI-RS and an SRS is configured (for example, when the BC is present), the UE may transmit the SRS resource by using the same spatial domain filter (spatial domain transmission filter) as a spatial domain filter (spatial domain reception filter) for reception of the SSB or CSI-RS. In this case, the UE may assume that a UE receive beam of the SSB or CSI-RS and a UE transmit beam of the SRS are the same.

Regarding a certain SRS (target SRS) resource, when spatial relation information related to another SRS (reference SRS) and the SRS (target SRS) is configured (for example, when the BC is absent), the UE may transmit the target SRS resource by using the same spatial domain filter (spatial domain transmission filter) as a spatial domain filter (spatial domain transmission filter) for transmission of the reference SRS. In other words, in this case, the UE may assume that a UE transmit beam of the reference SRS and a UE transmit beam of the target SRS are the same.

The UE may determine, based on a value of a certain field (for example, an SRS resource indicator (SRI) field) in DCI (for example, DCI format 0_1), a spatial relation for a PUSCH scheduled by the DCI. Specifically, the UE may use, for PUSCH transmission, spatial relation information (for example, an RRC information element “spatialRelationInfo”) of an SRS resource determined based on the value of the certain field (for example, the SRI).

When codebook based transmission is used for the PUSCH, the UE may be configured with two SRS resources by RRC, and one of the two SRS resources may be indicated for the UE by DCI (1-bit certain field). When non-codebook based transmission is used for the PUSCH, the UE may be configured with four SRS resources by the RRC, and one of the four SRS resources may be indicated for the UE by the DCI (2-bit certain field). RRC reconfiguration is necessary for use of a spatial relation other than the two or four spatial relations configured by the RRC.

Note that a DL-RS can be configured for spatial relations for the SRS resources used for the PUSCH. For example, for an SP-SRS, the UE is configured with spatial relations for a plurality of (for example, up to 16) SRS resources by RRC, and one of the plurality of SRS resources can be indicated for the UE by a MAC CE.

### (UL TCI State)

For Rel-16 NR, it is studied that a UL TCI state is used as a UL beam indication method. Notification of the UL TCI state is similar to notification of a UE DL beam (DL TCI state). Note that the DL TCI state and a TCI state for a PDCCH/PDSCH may be interchangeably interpreted.

A channel/signal for which the UL TCI state is configured (indicated) (which may be referred to as a target channel/RS) may be, for example, at least one of a PUSCH (PUSCH DMRS), a PUCCH (PUCCH DMRS), a random access channel (Physical Random Access Channel (PRACH)), an SRS, and the like.

An RS (source RS) being in a QCL relationship with the channel/signal may be, for example, a DL RS (for example, an SSB, a CSI-RS, a TRS, or the like) or a UL RS (for example, an SRS, an SRS for beam management, or the like).

In the UL TCI state, the RS being in a QCL relationship with the channel/signal may be associated with a panel ID for reception or transmission of the RS. The association may be explicitly configured (or indicated) by higher layer signaling (for example, RRC signaling, a MAC CE, or the like), or may be implicitly judged.

The correspondence between the RS and the panel ID may be configured by being included in UL TCI state information, or may be configured by being included in at least one of resource configuration information, spatial relation information, and the like for the RS.

A QCL type indicated by the UL TCI state may be existing QCL types A to D, may be another QCL type, or may include a certain spatial relation, a relevant antenna port (port index), and the like.

When a relevant panel ID is indicated (for example, indicated by DCI) for UL transmission, the UE may perform the UL transmission by using a panel corresponding to the panel ID. The panel ID may be associated with the UL TCI state, and when the UL TCI state is indicated (or activated) for a certain UL channel/signal, the UE may identify a panel used for transmission of the UL channel/signal, in accordance with a panel ID associated with the UL TCI state.

### (Single-Panel Transmission)

At least one of Transmission Schemes A and B below (single-panel UL transmission schemes A and B) may be applied to a single-panel UL transmission scheme or candidates for the single-panel UL transmission scheme. Note that, in the present disclosure, a panel/UE panel may be interpreted as a UE capability value set reported for each UE capability. In the present disclosure, different panels, different spatial relations, different joint TCI states, different TPC parameters, different antenna ports, and the like may be interchangeably interpreted.

### {Transmission Scheme A: Single-Panel Single-TRP UL Transmission}

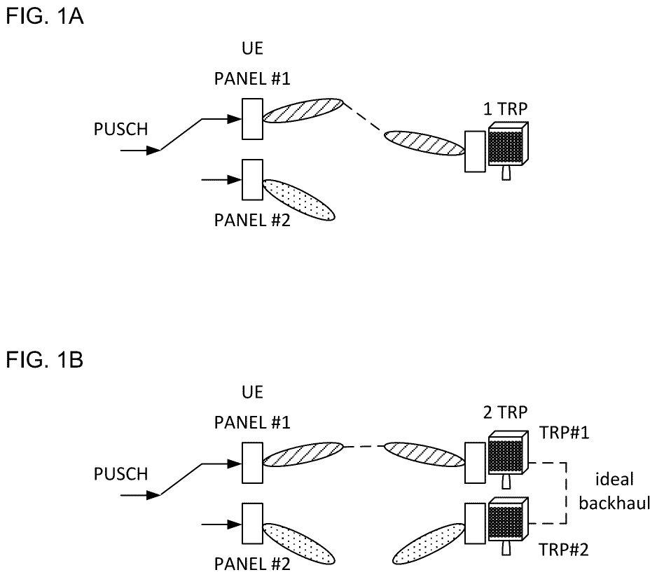

In Rel. 15 and Rel. 16, the UE uses a transmission scheme in which UL is transmitted to one TRP from only one beam and panel at one timing (FIG. 1A).

### {Transmission Scheme B: Single-Panel Multi-TRP UL Transmission}

In Rel. 17, it is studied that UL transmission from only one beam and panel is performed at one timing and repetition transmission to a plurality of TRPs is performed (FIG. 1B). In an example in FIG. 1B, the UE transmits a PUSCH to TRP #2 from panel #2 after transmitting a PUSCH to TRP #1 from panel #1 (switching the beam and panel). The two TRPs are connected to each other via an ideal backhaul.

### (Multi-Panel Transmission)

For Rel. 18 (or later versions), it is studied that for improvement of UL throughput/reliability, simultaneous UL transmission (for example, simultaneous multi-panel UL transmission (SiMPUL)) using a plurality of panels is supported for one or more TRPs. A multi-panel UL transmission scheme for a certain UL channel (for example, PUSCH/PUCCH) and the like is also under study.

As multi-panel UL transmission, up to X panels (for example, X=2) and up to Y panels (for example, Y=2) may be supported, for example. When UL precoding indication for a PUSCH is supported in the multi-panel UL transmission, a codebook for existing systems (for example, Rel. 16 (or earlier versions)) may be supported for multi-panel simultaneous transmission. When single-DCI and multi-DCI based multi-TRP operations are considered, the number of layers and the number of codewords (CWs) may be up to x (for example, x=4) and up to y (for example, y=2) in all the panels, respectively.

For a multi-panel UL transmission scheme or candidates for the multi-panel UL transmission scheme, at least one of schemes 1 to 3 below (multi-panel UL transmission schemes 1 to 3) is under study. Only one of Transmission Schemes 1 to 3 may be supported. A plurality of schemes including at least one of Transmission Schemes 1 to 3 may be supported, and one of the plurality of transmission schemes may be configured for the UE.

### {Transmission Scheme 1: Coherent Multi-Panel UL Transmission}

A plurality of panels may be synchronized with each other. All the layers are mapped to all the panels. A plurality of analog beams are indicated. An SRS resource indicator (SRI) field may be enhanced. This scheme may use up to four layers for UL.

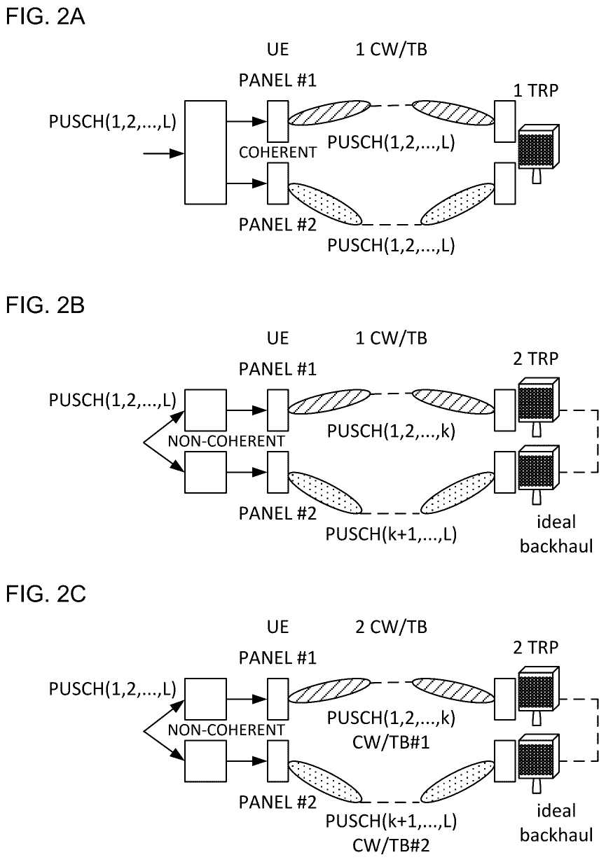

In an example in FIG. 2A, the UE maps one codeword (CW) or one transport block (TB) to L layers (PUSCH (1, 2, . . . , L)) to transmit L layers from each of the two panels. Panel #1 and panel #2 are coherent with each other. Transmission scheme 1 can obtain a gain by diversity. A total number of layers in the two panels is 2L. When a maximum value of the total number of layers is 4, a maximum value of the number of layers in one panel is 2.

{Transmission Scheme 2: Non-Coherent Multi-Panel UL Transmission with One Codeword (CW) or Transport Block (TB)}

A plurality of panels may not be synchronized with each other. Different layers are mapped to different panels and one CW or TB for PUSCHs from the plurality of panels. Layers corresponding to one CW or TB may be mapped to the plurality of panels. This transmission scheme may use up to four layers or up to eight layers for UL. When up to eight layers are supported, this transmission scheme may support one CW or TB using up to eight layers.

In an example in FIG. 2B, the UE maps 1 CW or 1 TB to k layers (PUSCH (1, 2, . . . , k)) and L-k layers (PUSCH (k+1, k+2, . . . , L)) to transmit k layers and L-k layers from panel #1 and panel #2, respectively. Transmission scheme 2 can obtain a gain by multiplexing and diversity. A total number of layers in the two panels is L.

{Transmission Scheme 3: Non-Coherent Multi-Panel UL Transmission with Two CWs or TBs}

A plurality of panels may not be synchronized with each other. Different layers are mapped to different panels and two CWs or TBs for PUSCHs from the plurality of panels. Layers corresponding to one CW or TB may be mapped to one panel. Layers corresponding to a plurality of CWs or TBs may be mapped to different panels. This transmission scheme may use up to four layers or up to eight layers for UL. When up to eight layers are supported, this transmission scheme may support up to four layers per CW or TB.

In an example in FIG. 2C, the UE maps CW #1 or TB #1 and CW #2 or TB #2 of the two CWs or 2 TBs to k layers (PUSCH (1, 2, . . . , k)) and L-k layers (PUSCH (k+1, k+2, . . . , L)), respectively, to transmit k layers and L-k layers from panel #1 and panel #2, respectively. Transmission scheme 3 can obtain a gain by multiplexing and diversity. A total number of layers in the two panels is L.

In each of the above-described transmission schemes, the base station may configure or indicate panel-specific transmission for UL transmission by using UL TCI or a panel ID. The UL TCI (UL TCI state) may be based on signaling similar to DL beam indication supported in Rel. 15. The panel ID may be implicitly or explicitly applied to transmission of at least one of a target RS resource or target RS resource set, a PUCCH, an SRS, and a PRACH. When the panel ID is explicitly notified, the panel ID may be configured in at least one of a target RS, a target channel, and a reference RS (for example, DL RS resource configuration or spatial relationship information).

For the above-described one or more transmission schemes/modes, multi-panel UL transmission (for example, simultaneous multi-panel transmission (Simultaneous Transmission across Multiple Panels) (STxMP)) for scheduling of a PUSCH based on one piece of DCI (single DCI)/scheduling of a PUSCH based on a plurality of pieces of DCI (multi-DCI) is under study.

In STxMP, the following schemes may be applied.
Single-DCI (S-DCI) space division multiplexing (SDM) scheme: different layers/DMRS ports for one PUSCH are separately precoded and simultaneously transmitted from different UE beams/panels.
S-DCI frequency division multiplexing (FDM)-A scheme: different parts of a frequency domain resource for one PUSCH transmission occasion are transmitted from different UE beams/panels.
S-DCI FDM-B scheme: two PUSCH transmission occasions for same/different RVs of the same TB are transmitted from different UE beams/panels on non-overlapping frequency domain resources and the same time domain resource.
S-DCI SFN based transmission scheme: the same PUSCHs/DMRSs are simultaneously transmitted from two different UE beams/panels.
S-DCI spatial domain repetition scheme: two PUSCH transmission occasions with different redundancy versions (RVs) of the same TB are transmitted from two different UE beams/panels on the same time and frequency resources.
M-DCI scheme: two PUSCHs overlapping each other (fully/partially overlapping each other in the time domain, fully/partially overlapping or non-overlapping each other in the frequency domain) are transmitted from two different UE beams/panels.

Note that, in the present disclosure, repetition transmission and transmission may be interchangeably interpreted. Transmission of a plurality of TBs may mean transmission of a plurality of the same TBs or transmission of different TBs.

### {Time Division Multiplexing (TDM)}

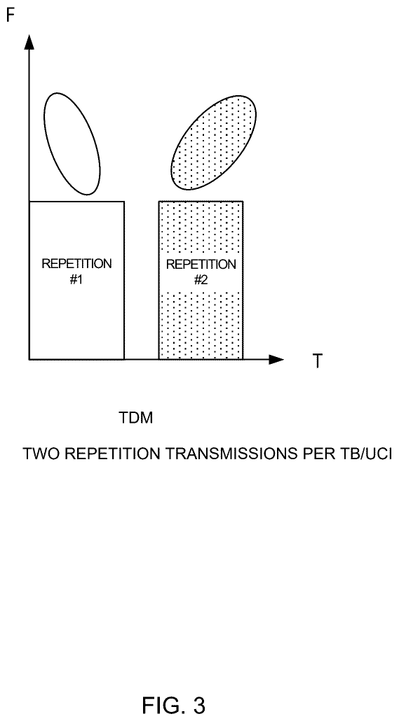

The UE may assume that PUSCH repetition transmissions to which time division multiplexing (TDM) is applied are scheduled in different time resources and the same frequency resource. FIG. 3 is a diagram to show an example of the PUSCH repetition transmissions to which TDM is applied. In FIG. 3, respective frequency resources for repetitions #1 and #2 of a PUSCH/PUCCH are the same, and respective time resources for repetitions #1 and #2 are different from each other.

### {Frequency Division Multiplexing (FDM)}

The UE may assume that PUSCH/PUCCH repetition transmissions to which frequency division multiplexing (FDM) is applied are scheduled in the same time resource and different frequency resource. In other words, when a plurality of coherent panels are used, the UE may transmit PUSCH/PUCCH repetition transmissions to which FDM is applied, in the same time resource and different frequency resources.

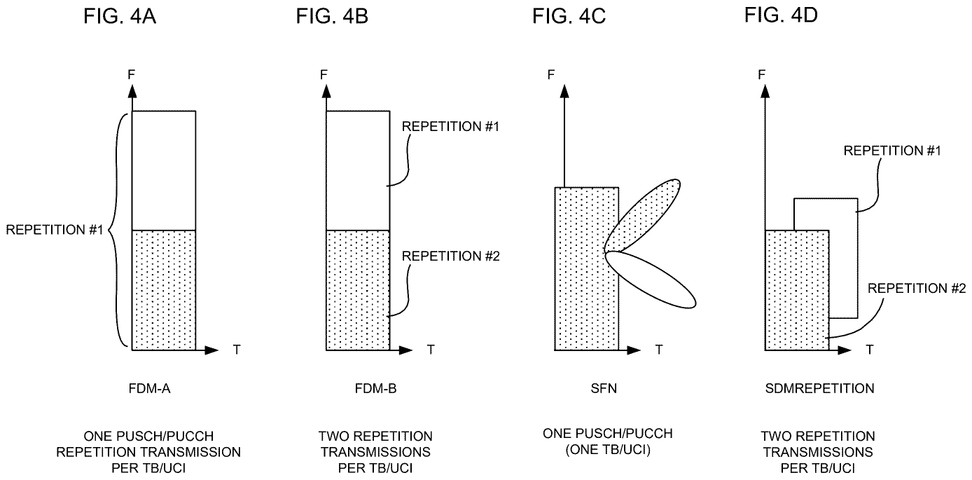

FIG. 4A is a diagram to show a first example of the repetition transmissions to which FDM (FDM-A) is applied. FIG. 4A shows an example in which one PUSCH/PUCCH repetition transmission is performed per TB/UCI.

FIG. 4B is a diagram to show a second example of the repetition transmissions to which FDM (FDM-B) is applied. FIG. 4B shows an example in which two PUSCH/PUCCH repetition transmissions are performed per TB/UCI.

FIG. 4C is a diagram to show an example of repetition transmissions to which a single frequency network (SEN) is applied. FIG. 4C shows an example in which one PUSCH/PUCCH is transmitted per TB/UCI by using different beams/panels.

### {Space Division Multiplexing (SDM)}

The UE may assume that PUSCH repetition transmissions to which space division multiplexing (SDM) is applied are scheduled in the same time resource and the same frequency resource. In other words, when a plurality of coherent panels are used, the UE may transmit PUSCH repetition transmissions to which SDM is applied, in the same time resource and the same frequency resource.

FIG. 4D is a diagram to show an example of the repetition transmissions to which SDM is applied. In FIG. 4D, respective time resources and frequency resources for repetitions #1 and #2 of a PUSCH/PUCCH are the same.

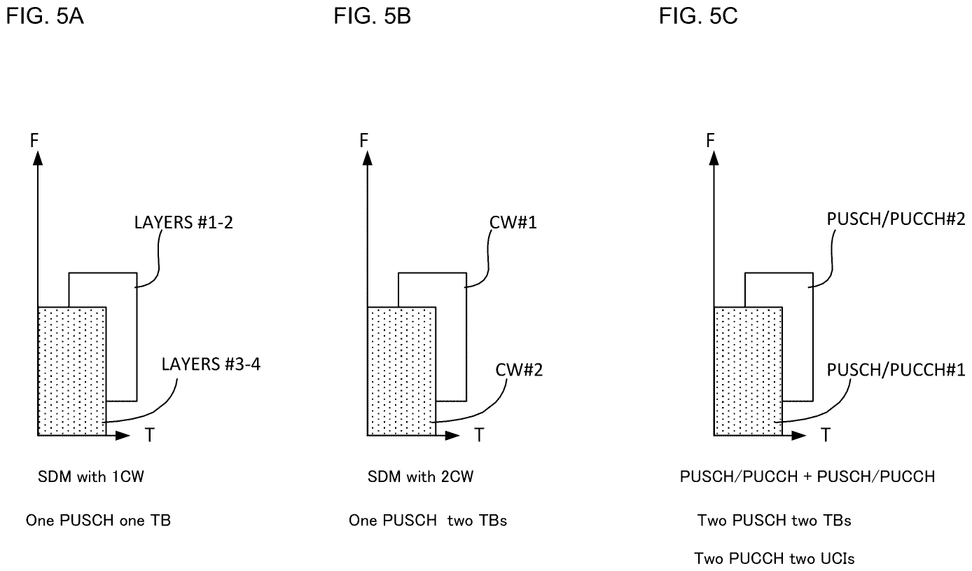

FIG. 5A is a diagram to show an example of the repetition transmissions to which SDM is applied with one CW. In FIG. 5A, respective time resources and frequency resources for layers #1-2 and layers #3-4 corresponding to a PUSCH/PUCCH are the same.

FIG. 5B is a diagram to show an example of the repetition transmissions to which SDM is applied with two CWs. In FIG. 5B, respective time resources and frequency resources for CW #1 and CW #2 corresponding to a PUSCH/PUCCH are the same.

FIG. 5C is a diagram to show an example of a case where at least parts of respective time resources and frequency resources for PUSCHs/PUCCHs corresponding to a plurality of respective TBs overlap each other. In FIG. 5C, respective time resources and frequency resources for PUSCH/PUCCH #1 corresponding to a first TB/UCI and PUSCH/PUCCH #2 corresponding to a second TB/UCI are the same.

Incidentally, for future radio communication systems (for example, Rel-18 NR), it is studied that a UE transmits a plurality of CWs or a plurality of TBs by using a PUSCH in such a manner as that described in STxMP described above. However, progress has not been sufficiently made on a study of details of this operation. For example, for a case where the plurality of CWs or the plurality of TBs are transmitted by the PUSCH, a study has not been sufficiently made on how to control scrambling, size calculation (for example, a TB size), repetition transmission, and the like. Unless the PUSCH transmission for the plurality of CWs or the plurality of TBs is appropriately performed, throughput reduction and degradation in communication quality may occur.

Thus, the inventors of the present invention came up with the idea of a method for enabling a UE to appropriately perform PUSCH transmission.

Embodiments according to the present disclosure will be described in detail as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

A spatial relation information Identifier (ID) (TCI state ID) and spatial relation information (TCI state) may be interchangeably interpreted. “Spatial relation information” may be interchangeably interpreted as “a set of spatial relation information”, “one or a plurality of pieces of spatial relation information”, and the like. The TCI state and the TCI may be interchangeably interpreted.

### (Radio Communication Method)

### First Embodiment

A first embodiment relates to scrambling of a PUSCH.

In the present disclosure, scrambling and a scramble may be interchangeably interpreted. For example, a scrambling sequence and a scramble sequence may be interchangeably interpreted.

The scrambling sequence applied to a CW of the PUSCH may be generated by using a scrambling sequence generator. To transmit a plurality of (for example, two) CWs on the PUSCH, the scrambling sequence generator for each CW may be initialized by using a different initial value cᵢₙᵢₜ.

Here, cᵢₙᵢₜ=n_{RNTI}·2¹⁵+q·2¹⁴+n^{ID} may be defined.

Here, n_{RNTI} may correspond to an RNTI associated with the PUSCH. q may correspond to an index of the CW (for example, 0 or 1). n_{ID} corresponds to a value of an ID used for initializing data scrambling of the PUSCH (which may be referred to as a data scrambling ID, a scramble ID, and so on).

n_{ID} may correspond to a value indicated by a higher layer parameter related to a data scrambling ID for the PUSCH (for example, an RRC parameter “dataScramblingIdentityPUSCH”) when a certain condition is satisfied. Otherwise, n_{ID} described above may correspond to a cell ID.

This certain condition may be, for example, a condition that “dataScrambling IdentityPUSCH” is configured, the RNTI is an RNTI of a certain type (such as a cell RNTI), and the PUSCH is not scheduled by using DCI format 0_0 in a common search space.

### <UCI on PUSCH>

Rel-15/16 NR supports a case that when a certain condition, such as a condition that a UE multiplexes UCI with PUCCH transmission temporally overlapping PUSCH transmission, is satisfied, the UE multiplexes at least part of this UCI with a PUSCH and transmits the PUSCH (UCI on PUSCH). UCI on PUSCH may be referred to as multiplexing UCI with a PUSCH, transmitting UCI on a PUSCH, piggybacking UCI on a PUSCH, and so on.

Rel-15/16 NR defines, for UCI on PUSCH, how a coded bit of a TB of one UL-SCH and a coded bit for UCI (for example, HARQ-ACK, CSI) are multiplexed with each other.

For future radio communication systems (for example, Rel-18 NR), progress has been made on a study of whether UCI is multiplexed with both CWs/TBs or only one CW/TB when a PUSCH for transmitting two CWs/TBs is scheduled for a UE.

For example, when a PUSCH for transmitting two CWs/TBs is scheduled, and this PUSCH is used for UCI on PUSCH, the UE may multiplex this UCI with both of the two CWs/TBs.

When a PUSCH for transmitting two CWs/TBs is scheduled, and this PUSCH is used for UCI on PUSCH, the UE may multiplex this UCI with only one CW/TB (for example, CW #0).

The latter case may define that a scrambled bit of the PUSCH for a CW/TB (for example, CW #1) with which the UCI is not multiplexed is always b^{~(q)} (i)=(b^{(q)} (i)+c^{(q)} (i)) mod 2. Here, b^{~} may be expressed by adding ~ to the top of b (w tilde). Note that, as described above, q corresponds to a CW index. i may be expressed by an integer from 0 to M^{(q)}_{bit}−1. An existing specification includes a case where an equation different from this equation is used for scrambling in consideration of UCI on PUSCH, but such an equation may not be considered for a PUSCH for a CW with which UCI is not multiplexed.

Here, b^{(q)} (i) may correspond to a bit block (or a bit string) of a CW. c^{(q)} (i) may correspond to a scrambling sequence. mod may represent modulo operation. For example, (A) mod (B) corresponds to a remainder obtained by dividing A by B. M^{(q)}_{bit} may correspond to the number of coded bits for transmission on a physical channel (for example, a PUSCH).

According to the first embodiment described above, it is possible to appropriately control a scrambling sequence for a PUSCH in a case where multi-TRP is used.

### Second Embodiment

A second embodiment relates to PUSCH repetition transmission.

Rel-16 NR defines that, in a case where slots sⱼ of serving cells j (j is 0, 1, 2, . . . , J−1) temporally overlap each other, when (sum total of) data rate(s) for these slots exceeds a specific data rate (threshold) in the time period, a UE may not perform processing on PUSCH transmission in each slot sⱼ (may not transmit a PUSCH).

The specific data rate is a maximum data rate computed based on the number of configured cells or the like. On the other hand, the data rate for slots sⱼ is calculated based on the number (M) of TBs transmitted in slots sⱼ.

The UE may count (the number of) respective actual repetition transmissions separately for M when applying repetition transmission type B (in other words, M may be counted based on respective actual repetition transmissions).

For example, in STxMP, the UE may count (the number of) respective actual repetition transmissions separately for M when applying an S-DCI FDM-B scheme. The UE may also count (the number of) respective actual repetition transmissions separately for M when applying an S-DCI SDM scheme.

According to the second embodiment described above, the number of TBs can also be appropriately counted for repetition transmission with 1 TB, and thus it is possible to appropriately control PUSCH repetition transmission.

### Third Embodiment

A third embodiment relates to a transport block size (TBS).

### <Transport Block Size>

In Rel-16 NR, a table (MCS table) associating a modulation order, a coding rate (also referred to as an assumed coding rate, a target coding rate, and so on), and an index (for example, an MCS index) indicating the modulation order and the coding rate may be defined (may be stored in a UE). Note that the MCS table may associate spectral efficiency in addition to the three entries.

The UE may receive DCI for scheduling of a PUSCH (at least one of a UL grant and DCI format 0_x (x is, for example, 0, 1, 2, or the like)) and may determine a modulation order (Qm) and a coding rate (R) for the PUSCH, based on an MCS table and an MCS index included in the DCI. The DCI for the scheduling may be referred to as scheduling DCI.

In Rel-16 NR, the UE may determine a TBS for the PUSCH by using at least one of Step 1) to Step 4) described below.

### Step 1)

The UE determines the number of RES (N_{RE}) in a slot.

Specifically, the UE may determine the number of RES (N′_{RE}) allocated to the PUSCH in 1 PRB. For example, the UE may determine the number of RES (N′_{RE}) allocated to the PUSCH in 1 PRB, based on at least one parameter described in Equation (1) below.

$${N}_{RE}^{′} = {N}_{SC}^{RB} \cdot {N}_{symb}^{sh} - {N}_{DMRS}^{PRB} - {N}_{oh}^{PRB} \qquad Equation ( 1 )$$

Here, N^{RB}_{SC} is the number of subcarriers per 1 RB, and N^{RB}_{SC} may equal, for example, 12. N^{sh}_{symb} is the number of symbols (for example, OFDM symbols) scheduled in a slot.

N^{PRB}_{DMRS} is the number of REs for DMRS per PRB in a scheduled period. The number of REs for DMRS may include overhead for a group related to code division multiplexing (CDM) of a DMRS indicated by the scheduling DCI.

N^{PRB}ₒₕ may be a value configured by a higher layer parameter. For example, N^{PRB}ₒₕ is overhead indicated by a higher layer parameter (Xoh-PUSCH), and may be any one of 0, 6, 12, and 18. When Xoh-PUSCH is not configured (notified) for the UE, Xoh-PUSCH may be set to 0. Xoh-PUSCH is set to 0 in message 3 (msg3) in random access procedure.

The UE may determine a total number (N_{RE}) of REs allocated to the PUSCH. The UE may determine the total number (N_{RE}) of RES allocated to the PUSCH, based on the number of RES (N′_{RE}) allocated to the PUSCH in 1 PRB and a total number (n_{PRB}) of PRBs allocated to the UE (for example, Equation (2) below).

$${N}_{RE} = min ( 156 , {N}_{RE}^{′} ) \cdot {n}_{PRB} \qquad Equation ( 2 )$$

Note that the UE may quantize the number of RES (N′_{RE}) allocated to the PUSCH in 1 PRB, in accordance with a certain rule, and may determine the total number (N_{RE}) of REs allocated to the PUSCH, based on the quantized number of REs and a total number (n_{PRB}) Of PRBs allocated to the UE.

### Step 2)

The UE determines an intermediate number (N_{info}) of an information bit. Specifically, the UE may determine the intermediate number (N_{info}), based on at least one parameter described in Equation (3) below. Note that the intermediate number (N_{info}) may be referred to as a temporary TBS (TBSₜₑₘₚ) and so on.

$${N}_{info} = {N}_{RE} \cdot R \cdot {Q}_{m} \cdot u \qquad Equation ( 3 )$$

Here, N_{RE} is a total number of REs allocated to the PUSCH. R is a coding rate associated with an MCS index included in DCI in an MCS table. Qₘ is a modulation order associated with an MCS index included in the DCI in the MCS table. u is the number of layers for the PUSCH.

### Step 3)

When the intermediate number (N_{info}) of the information bit determined in Step 2) is less than or equal to (or less than) a certain threshold (for example, 3824), the UE may quantize the intermediate number and may determine the quantized intermediate number (N′_{info}). The UE may compute the quantized intermediate number (N′ info), for example, by using Equation (4).

$${N}_{info}^{′} = max ( 24 , {2}^{n} \cdot floor ( {N}_{info} / 2 ) ) \qquad Equation ( 4 )$$

$$Here , n = max ( 3 , floor ( {log}_{2} ( {N}_{info} ) )$$

The UE may find the closest TBS not less than the quantized intermediate number (N′_{info}) by using a certain table (for example, a table associating a TBS with an index (also referred to as a quantization table or a TBS table and so on)).

### Step 4)

On the other hand, when the intermediate number (N_{info}) of the information bit determined in Step 2) is greater than (or greater than or equal to) a certain threshold (for example, 3824), the UE may quantize the intermediate number (N_{info}) and may determine the quantized intermediate number (N′_{info}). The UE may compute the quantized intermediate number (N′_{info}), for example, by using Equation (5). Note that the round function may round up a fraction.

$${N}_{info}^{′} = max ( 3840 , {2}^{n} \times round ( ( {N}_{info} - 24 ) / {2}^{n} ) ) \qquad Equation ( 5 )$$

$$Here , n = floor ( {log}_{2} ( {N}_{info} - 24 ) ) - 5.$$

Here, when the coding rate (R) associated with the MCS index in the DCI in the above-described MCS table is less than or equal to (or less than) a certain threshold (for example, ¼), the UE may determine a TBS, based on at least one parameter described in Equation (6) below (for example, by using Equation (6)).

$$TBS = 8 \cdot C \cdot ceil ( ( {N}_{info}^{′} + 24 ) / ( 8 \cdot C ) ) - 24 \qquad Equation ( 6 )$$

$$Here , C = ceil ( ( {N}_{info}^{′} + 24 ) / 3816 ) .$$

N′_{info} is a quantized intermediate number, and may be computed, for example, by using Equation (5) above. C may be the number of code blocks (CBs) obtained by dividing a TB.

On the other hand, when the above-described coding rate (R) is greater than (or greater than or equal to) a certain threshold (for example, ¼), and the quantized intermediate number (N′ info) of the information bit is greater than (or greater than or equal to) a certain threshold (for example, 8424), the UE may determine a TBS, based on at least one parameter described in Equation (7) below (for example, by using Equation (7)).

$$TBS = 8 \cdot C \cdot ceil ( ( {N}_{info}^{′} + 24 ) / ( 8 \cdot C ) ) - 24 \qquad Equation ( 7 )$$

$$Here , C = ceil ( ( {N}_{info}^{′} + 24 ) / 8424 ) .$$

When the above-described coding rate (R) is less than or equal to (or less than) a certain threshold (for example, ¼), and the quantized intermediate number (N′_{info}) is less than or equal to (or less than) a certain threshold (for example, 8424), the UE may determine a TBS, based on at least one parameter described in Equation (8) below (for example, by using Equation (8)).

$$TBS = 8 \cdot ceil ( ( {N}_{info}^{′} + 24 ) / 8 ) - 24 \qquad Equation ( 8 )$$

In this manner, in Rel-16 NR, the UE determines an intermediate number (N_{info}) of an information bit, based on at least one of the number (N_{RE}) of RES, a coding rate (R), a modulation order (Qm), and the number of layers available for a PUSCH in a slot, and determines a TBS for the PUSCH, based on the intermediate number (N′_{info}) obtained by quantizing the intermediate number (N_{info}).

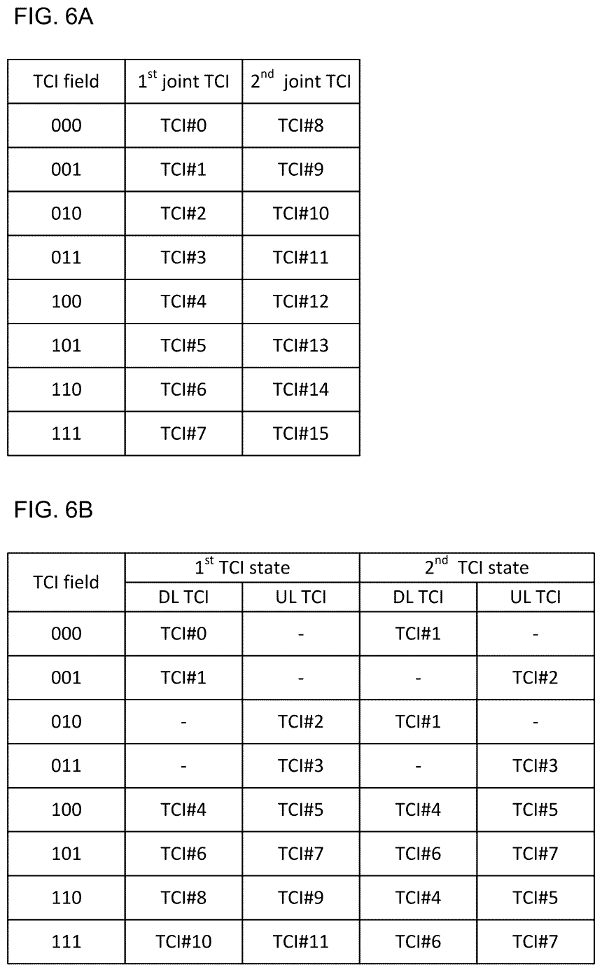

In the third embodiment, when a certain condition is satisfied, the TBS for the PUSCH may be determined based on a method obtained by modifying the TBS determination method for Rel-16 NR described above. For example, when a certain multi-TRP/multi-panel PUSCH repetition scheme (for example, a scheme in which one CW is repeated in one slot) is configured, and a codepoint of a DCI field “Transmission Configuration Indication” indicates two unified UL TCI states (for example, two joint TCI states (see FIG. 6A), or two separate UL TCI states and zero to two separate DL TCI states (see FIG. 6B)), the UE may determine the TBS as follows.

FIG. 6A is a diagram to show an example of the TCI states (joint TCI states) indicated by the TCI codepoint. FIG. 6B is a diagram to show an example of the TCI states (separate TCI states) indicated by the TCI codepoint.

A symbol/RB/RE allocated to a PUSCH associated with one of the TCI states (for example, a first (or second) TCI state) (or TRP/panel IDs) in the TCI codepoint may be used for TBS determination using single MCS indication. The determined TBS may be assumed (the same TBS may be used) for a symbol/RB/RE allocated to a PUSCH associated with the other (for example, second (or first)) TCI state.

In this case, in the TBS determination, only a PRB/symbol/number of REs corresponding to one of the TCI states (first (or second) TCI state) (or TRP/panel IDs) may be computed. The determined TBS and the modulation order may also be applied to a PUSCH corresponding to the other TCI state (or TRP/panel ID).

A maximum TBS size supported by the certain PUSCH repetition scheme may be determined based on a UE capability.

For example, when an S-DCI FDM-B scheme is configured, a codepoint of a DCI field “Transmission Configuration Indication” indicates two unified UL TCI states, and a DCI field “Antenna Port(s)” indicates a DM-RS port in one CDM group, the UE may determine the TBS as follows.

The UE may determine the TBS, based on assumption that n_{PRB} in Equation (2) “N_{RE}=min(156, N′_{RE})·n_{PRB}” in Step 1 described above is a total number of allocated PRBs corresponding to the first TCI state. The UE applies the determined TBS to a PUSCH transmission occasion corresponding to the first TCI state. The UE may apply the determined TBS to a PUSCH transmission occasion associated with the second TCI state.

When PUSCH repetition transmission with an S-DCI TDM (or SDM) scheme is supported/configured, and a codepoint of a DCI field “Transmission Configuration Indication” indicates two unified UL TCI states, the UE may determine the TBS as follows.

The UE may determine the TBS, based on assumption that N^{sh}_{symb} in Equation (1) “N′_{RE}=N^{RB}_{SC}·N^{sh}_{symb}−N^{PRB}_{DMRS}−N^{PRB}ₒₕ” in Step 1 described above is the number of PUSCH allocation symbols in a slot corresponding to the first TCI state. The UE applies the determined TBS to a PUSCH transmission occasion corresponding to the first TCI state. The UE may apply the determined TBS to a PUSCH transmission occasion associated with the second TCI state.

For TBS computation for a certain PUSCH (for example, a PUSCH to which a certain repetition scheme is applied/PUSCH scheduled by a certain DCI format), a scaling factor S for determining N_{info} in Step 2 described above may be introduced. For example, the UE may determine N_{info} in accordance with N_{info}=S·N_{RE}·R·Qₘ·U in place of Equation (3).

The scaling factor S may be determined based on a field included in DCI for scheduling the PUSCH (which may be referred to as, for example, a “TB scaling field”) (for example, S=1, 0.5, 0.25, and the like for field values=“00,” “01,” “10,” and the like, respectively). Note that the relationship between this field value and the corresponding S value may be configured by higher layer signaling.

In the above-described repetition transmission scheme (for example, S-DCI FDM-B scheme), a PRB/symbol indicated by a frequency domain resource allocation (FDRA)/time domain resource allocation (TDRA) field may be total PRBs/symbols based on two repetitions. In this case, the UE may calculate the TBS, based on a PRB/symbol corresponding to one of the TCI states (for example, first (or second) TCI state), instead of all the PRBs/symbols indicated by DCI.

When DCI design is different from that for existing DCI (for example, when two independent FDRA/TDRA fields are configured for two repetitions), the UE may calculate each TBS, based on a PRB/symbol of the FDRA/TDRA field indicated for each repetition.

According to the third embodiment described above, it is possible to appropriately calculate a TBS.

### Fourth Embodiment

A fourth embodiment relates to judgment of a modulation order for PUSCH.

In the fourth embodiment, the modulation order for PUSCH may be determined when a certain condition is satisfied. For example, when the certain PUSCH repetition scheme described above (for example, the scheme in which one CW is repeated in one slot) is configured, and a codepoint of a DCI field “Transmission Configuration Indication” indicates two unified UL TCI states (for example, two joint TCI states (see FIG. 6A), or two separate UL TCI states and zero to two separate DL TCI states (see FIG. 6B)), the UE may determine the modulation order as follows.
For a PUSCH associated with one of the TCI states (for example, first (or second) TCI state), the UE may judge a modulation order for PUSCH, based on an MCS table and an MCS index included in DCI for scheduling the PUSCH.
The UE may apply the judged modulation order to a PUSCH associated with the other (for example, second (or first)) TCI state.

For example, when an S-DCI FDM-B scheme is configured, a codepoint of a DCI field “Transmission Configuration Indication” indicates two unified UL TCI states, and a DCI field “Antenna Port(s)” indicates a DM-RS port in one CDM group, the UE may judge and apply the modulation order as follows.
For a PUSCH associated with one of the TCI states (for example, first (or second) TCI state), the UE may judge a modulation order for PUSCH, based on an MCS table and an MCS index included in DCI for scheduling the PUSCH.
The UE may apply the judged modulation order to a PUSCH transmission occasion associated with the other (for example, second (or first)) TCI state.

Different modulation orders may be applied in respective PUSCHs/TBs associated with the first TCI state and the second TCI state. In this case, enhancing an existing DCI field may allow one piece of scheduling DCI to indicate two modulation orders. With this, performance enhancement is expected in a case where RSRP/path loss (between the UE and each TRP) differs for each TB.

According to the fourth embodiment described above, it is possible to appropriately judge a modulation order.

### <Supplement>

At least one of the above-described embodiments may be applied only to the UE that has reported a specific UE capability or that supports the specific UE capability.

The specific UE capability may indicate at least one of the following:
support of specific processing/operation/control/information for at least one of the above-described embodiments,
multi-panel simultaneous transmission/reception being supported by the UE,
whether to support two CWs for a PUSCH scheduled by one piece of DCI (single DCI),
whether to support UCI multiplexed with two CWs for a PUSCH scheduled by one piece of DCI,
whether to support UCI multiplexed with one of two CWs for a PUSCH scheduled by one piece of DCI,
whether to support two CWs mapped to 5 to 6 layers,
whether to support two CWs mapped to 5 to 8 layers,
whether to support two CWs mapped to 2 to 4 layers,
whether to support a PUSCH with up to 6 layers,
whether to support a PUSCH with up to 8 layers,
whether to support up to 6 SRS/PUSCH ports,
whether to support up to 8 SRS/PUSCH ports,
whether to support up to 6 DMRS ports, and
whether to support up to 8 DMRS ports.

The specific UE capability may be capability applied over all the frequencies (commonly irrespective of frequency), capability per frequency (for example, a cell, a band, a BWP), capability per frequency range (for example, Frequency Range 1 (FR1), FR2, FR3, FR4, FR5, FR2-1, FR2-2), or capability per subcarrier spacing (SCS).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied to at least one PUSCH transmission of the following.
Simultaneous multi-panel UL transmission with four or less layers
UL transmission with four to eight layers
Single-panel UL transmission with four or less layers

At least one of the above-described embodiments may be applied when specific information associated with the above-described embodiment (or operation for the above-described embodiment) is configured/activated/triggered for the UE by higher layer signaling/physical layer signaling. For example, the specific information may be information indicating enabling of two CWs for a PUSCH (which may be referred to as, for example, an RRC parameter “TwoCWForPUSCH”), any RRC parameter for specific release (for example, Rel. 18), or the like.

When not supporting at least one of the specific UE capabilities or not configured with the specific information, the UE may apply operation of Rel. 15/16, for example.

### (Supplementary Note)

Regarding one embodiment of the present disclosure, the following supplementary notes of the invention will be given.

### {Supplementary Note 1}

A terminal including:
a transmitting section that transmits a plurality of transport blocks to a plurality of transmission/reception points (TRPs) by using an uplink shared channel (Physical Uplink Shared Channel (PUSCH)); and
a control section that judges a parameter related to an initial value for generation of a scrambling sequence to be applied to the PUSCH.

### {Supplementary Note 2}

The terminal according to supplementary note 1, wherein the transmitting section multiplexes uplink control information only with one transport block of the plurality of transport blocks and transmits the multiplexed uplink control information.

### (Supplementary Note)

Regarding one embodiment of the present disclosure, the following supplementary notes of the invention will be given.

### {Supplementary Note 1}

A terminal including:
a receiving section that receives downlink control information (DCI) for scheduling an uplink shared channel (Physical Uplink Shared Channel (PUSCH)) to be repeatedly transmitted;
a transmitting section that transmits a plurality of transport blocks to a plurality of transmission/reception points (TRPs) by using the PUSCH; and
a control section that determines a size of at least one of the plurality of transport blocks, based on a codepoint of a transmission configuration indication (TCI) field included in a field of the DCI.

### {Supplementary Note 2}

The terminal according to supplementary note 1, wherein the control section judges a modulation order for the PUSCH, based on the TCI codepoint.

### {Supplementary Note 3}

The terminal according to supplementary note 1 or 2, wherein the control section judges a number of repetitions of transmission of the PUSCH, based on a certain condition.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

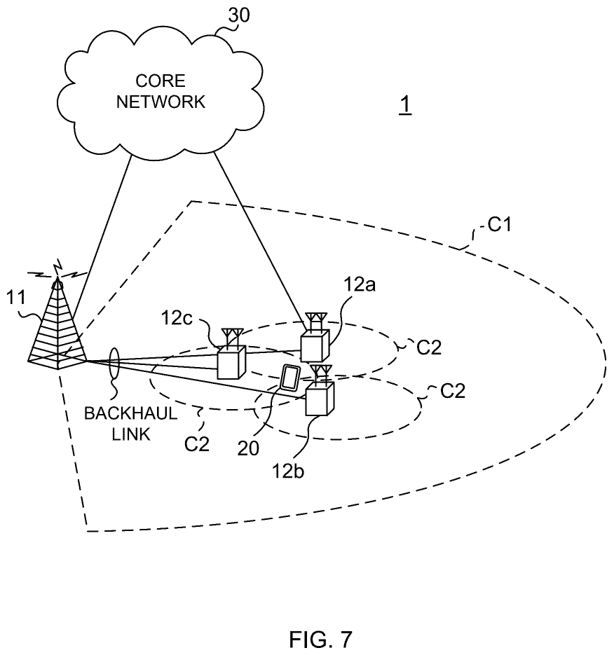

FIG. 7 is a diagram to show an example of a schematic structure of the radio communication system according to one embodiment. The radio communication system 1 (which may be simply referred to as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF) such as a User Plane Function (UPF), an Access and Mobility management Function (AMF), a Session Management Function (SMF), Unified Data Management (UDM), an ApplicationFunction (AF), a Data Network (DN), a Location Management Function (LMF), and operation, administration, and maintenance (Management) (OAM). Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

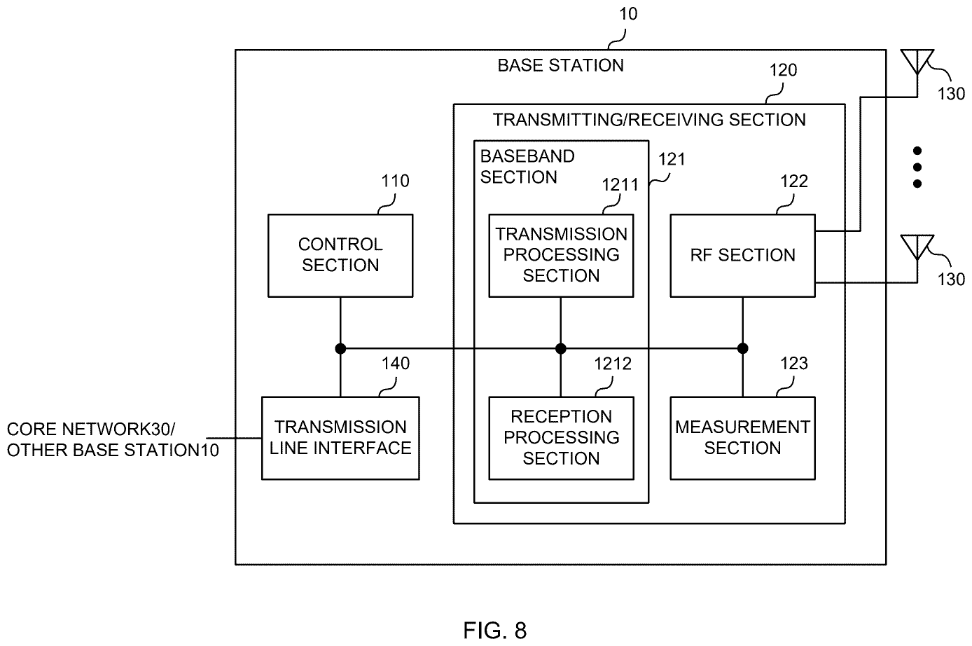

FIG. 8 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may transmit/receive (perform backhaul signaling of) a signal with an apparatus (for example, a network node providing NFs) included in the core network 30 or other base stations 10, and so on, and may acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may receive a plurality of transport blocks from a plurality of transmission/reception points (TRPs) by using an uplink shared channel (Physical Uplink Shared Channel (PUSCH)). The transmitting/receiving section 120 may receive uplink control information multiplexed only with one transport block of the plurality of transport blocks. The transmitting/receiving section 120 may transmit downlink control information (DCI) for scheduling repetition transmission of an uplink shared channel (Physical Uplink Shared Channel (PUSCH)).

The control section 110 may judge a parameter related to an initial value for generation of a scrambling sequence to be applied to the PUSCH. The control section 110 may judge a size of the transport block, based on a transmission configuration indication (TCI) codepoint included in a field of the DCI. The control section 110 may judge a modulation order for the PUSCH, based on the TCI codepoint. The control section 110 may judge a number of repetitions of transmission of the PUSCH, based on a certain condition.

### (User Terminal)

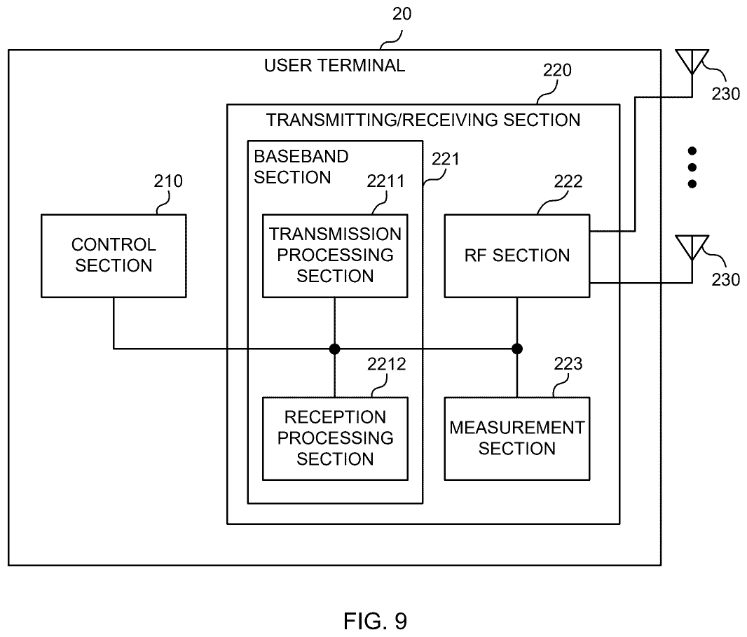

FIG. 9 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-S-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may transmit a plurality of transport blocks to a plurality of transmission/reception points (TRPs) by using an uplink shared channel (Physical Uplink Shared Channel (PUSCH)). The transmitting/receiving section 220 may multiplex uplink control information only with one transport block of the plurality of transport blocks and may transmit the multiplexed uplink control information. The transmitting/receiving section 220 may receive downlink control information (DCI) for scheduling transmission of an uplink shared channel (Physical Uplink Shared Channel (PUSCH)) to be repeatedly transmitted.

The control section 210 may judge a parameter related to an initial value for generation of a scrambling sequence to be applied to the PUSCH. The control section 210 may determine a size of the transport block, based on a transmission configuration indication (TCI) codepoint included in a field of the DCI. The control section 210 may judge a modulation order for the PUSCH, based on the TCI codepoint. The control section 210 may judge a number of repetitions of transmission of the PUSCH, based on a certain condition.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

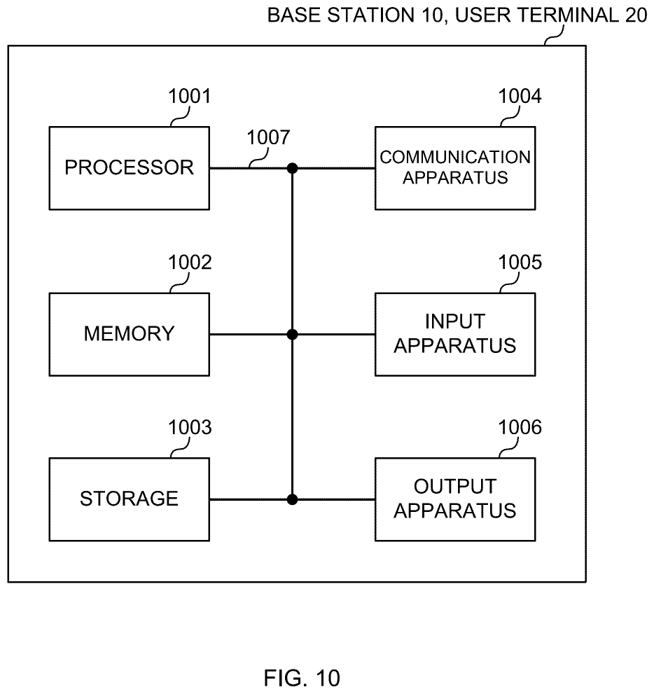

For example, a base station, a user terminal, and so on according to one embodiment of the present disclosure may function as a computer that executes the processes of the radio communication method of the present disclosure. FIG. 10 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CES).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a case that a base station transmits information to a terminal may be interchangeably interpreted as a case that the base station indicates, for the terminal, control/operation based on the information.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

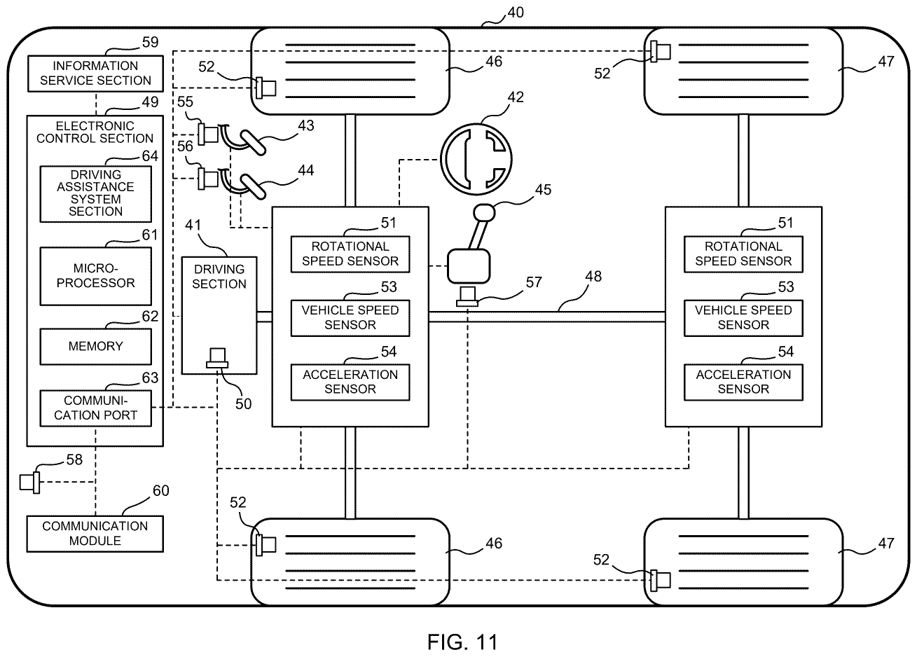

FIG. 11 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or smaller than,” “smaller than,” “equal to or larger than,” “larger than,” “equal to,” and the like may be interchangeably interpreted. In the present disclosure, words such as “good,” “poor,” “large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example, “highest” may be interpreted as “i-th highest,” and vice versa).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1.-4. (canceled)

5. A terminal comprising:
a transmitter that reports a capability of supporting an uplink (UL) transmission with eight antenna ports, and transmits a plurality of codewords using a physical uplink shared channel (PUSCH); and
a processor that uses different initial values that are specified for respective indexes of the plurality of codewords, to generate a scrambling sequence to be applied to the PUSCH.

6. The terminal according to claim 5, wherein the processor multiplexes uplink control information (UCI) on one codeword of the plurality of codewords in transmission of the PUSCH.

7. A radio communication method for a terminal, comprising:
reporting a capability of supporting an uplink (UL) transmission with eight antenna ports;
transmitting a plurality of codewords using a physical uplink shared channel (PUSCH); and
using different initial values that are specified for respective indexes of the plurality of codewords, to generate a scrambling sequence to be applied to the PUSCH.

8. A base station comprising:
a receiver that receives a report regarding a capability of supporting an uplink (UL) transmission with eight antenna ports, and receives a plurality of codewords using a physical uplink shared channel (PUSCH); and
a processor that controls reception of the PUSCH that a terminal transmits using different initial values that are specified for respective indexes of the plurality of codewords to generate a scrambling sequence to be applied to the PUSCH.

9. A system comprising a terminal and a base station, wherein
the terminal comprises:
a transmitter that reports a capability of supporting an uplink (UL) transmission with eight antenna ports, and transmits a plurality of codewords using a physical uplink shared channel (PUSCH); and
a processor that uses different initial values that are specified for respective indexes of the plurality of codewords, to generate a scrambling sequence to be applied to the PUSCH, and
the base station comprises:
a receiver that receives a report regarding the capability and receives the PUSCH.
